(19) United States
(12) Patent Application Publication
(10) Pub. No.: US 2024/0057761 A1
(43) Pub. Date: Feb. 22, 2024

(54) ALTERATION OF ELECTRONIC DESK HEIGHT BASED ON USER CONTEXT

(71) Applicant: Lenovo (Singapore) Pte. Ltd., Singapore (SG)

(72) Inventors: Russell Speight VanBlon, Raleigh, NC (US); Robert J. Kapinos, Durham, NC (US); Scott Li, Cary, NC (US); Robert James Norton, JR., Raleigh, NC (US)

(21) Appl. No.: 17/820,053

(22) Filed: Aug. 16, 2022

(51) Int. Cl. A47B 9/00; A47B 21/02

(52) U.S. Cl. CPC A47B 9/00; A47B 21/02; A47B 2200/0061; A47B 2200/0062

(57) ABSTRACT

In one aspect, a device includes at least one processor and storage accessible to the at least one processor. The storage includes instructions executable by the at least one processor to identify a context associated with a user and to alter a height of an electronic desk based on the context.

### FIELD

The disclosure below relates to technically inventive, non-routine solutions that are necessarily rooted in computer technology and that produce concrete technical improvements. In particular, the disclosure below relates to techniques for alternation of an electronic desk's height based on user context and other triggers.

### BACKGROUND

As recognized herein, most desks of adjustable height take far too long to adjust their height, frustrating the user who is present. This also leads to delays and disruptions in being able to use the desk. There are currently no adequate solutions to the foregoing technological problem.

### SUMMARY

Accordingly, in one aspect a device includes at least one processor and storage accessible to the at least one processor. The storage includes instructions executable by the at least one processor to identify a context associated with a user and to alter a height of an electronic desk based on the context.

In one example implementation, the context may be identified based on input from a camera. So, for example, the instructions may be executable to determine that the user is not proximate to the electronic desk based on the input from the camera and to alter the height of the electronic desk based on the determination.

Also in an example implementation, the context may be identified based on input from at least one motion sensor such as an accelerometer and/or gyroscope. The context may also be identified based on input from a global positioning system (GPS) transceiver, based on data in an electronic calendar associated with the user, based on a current time of day, and/or based on the absence of the user within a proximity to the desk.

As still another example, the device may be a first device, and the context may be identified based on communication a second device different from the first device. The second device may be a network-enabled chair and/or an electronic home appliance. Additionally or alternatively, the second device may be located in a first location different from a second location at which the electronic desk is located, and the context may be identified based on user interaction with the second device.

Still further, in certain example embodiments the context may be related to the user engaging or not engaging in physical exercise. Here the instructions may be executable to lower the height of the electronic desk based on the user engaging in physical exercise, and to raise the height of the electronic desk based on the user not engaging in physical exercise.

Also in some examples, the device may include the electronic desk itself.

In another aspect, a method includes identifying a context associated with a user and altering a height of an electronic desk based on the context.

In one example implementation, the method may include altering the height of the electronic desk a threshold time before the context is identified to occur.

Also in an example implementation, the context may be identified using human presence detection and input from a time-of-flight sensor.

In still another aspect, at least one computer readable storage medium (CRSM) that is not a transitory signal includes instructions executable by at least one processor to identify a trigger for autonomously altering a height of an electronic desk and to alter the height of the electronic desk based on the trigger.

In certain example embodiments, the trigger may include a user switching chairs used to sit at the electronic desk, and/or the user changing a height of a chair used to sit at the electronic desk.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is an example explanatory diagram illustrating present principles;

FIG. 4 shows example logic in example flow chart format that may be executed by a device consistent with present principles;

FIG. 5 shows an example settings graphical user interface (GUI) that may be presented on a display to configure one or more settings of a device to operate consistent with present principles; and

FIG. 6 shows an example GUI that may be presented on a display to notify a user of an impending desk height change.

### DETAILED DESCRIPTION

Among other things, the detailed description below discusses an IoT smart desk that can raise and lower itself at times when the user will not have to wait for the height change to be performed. In various examples, a laptop computer, desktop computer, smartphone, stationary camera, or other device may communicate with the desk to provide information as to when the user steps away from the desk. This may allow the desk to move at a time least disruptive to the user. Sensors that may be used to accomplish this may include camera to detect when the user steps away, a wearable device that knows the user is walking, GPS transceivers for location tracking, accelerometers and gyroscopes, etc. Additionally, other IoT devices may also be leveraged to know when the user is interacting with them (e.g., a smart coffee maker, a digital assistant in another room, etc.).

What's more, desk up and down time may be analyzed for standing or sitting too long, respectively. Too long may be a default value set by the end-user, a system admin, the desk's manufacturer, a healthcare professional, etc. The desk may therefore toggle heights at the next opportunity (e.g., when the user steps away). The user may also configure specific contexts and/or desired time ranges for the desk to change height based on their daily habits and activities of going to and from the desk.

For example, the desk may be raised or lower in various contexts/scenarios including but not limited to the user stepping away for a restroom break or to get the mail, the user leaving for a lunchtime meal, snack, or coffee, or even based on a chair-height correlation. E.g., if the user sets a chair up or down, the desk height may be adjusted accordingly to maintain the same user head height/position, chair seat back height, or seat bottom height relative to the top of the desk itself. As another example, if the user switches chairs, the desk height may be adjusted accordingly to maintain the same relative height (e.g., the chair may be a smart chair that can communicate its current height setting, or camera input may be used to determine the current chair height). Thus, multiple desk heights may be configured for variable-height chairs or even multiple chairs.

As other examples, the user may configure the desk to change heights between meetings (e.g., as indicated in an electronic calendar), responsive to the user ending a telephone call or video conference at another device, or responsive to conclusion of another event, whether the user is currently proximate to the desk or not. The user may also configure the desk to change heights during a meeting such as a video conference when the user is muted for at least a threshold amount of time (from streaming audible input to others), and/or when the user is not participating (and not muted), or even when another person walks up to talk to the user in person proximate to the desk. Still other activities may be specified by the user for triggering desk height alteration. For instance, another example context that may be selected is the device identifying that the user is about to leave the desk's proximity or begin a meeting, as may be identified from audible input from a microphone and execution of natural language understanding to identify the context of the user leaving or beginning a meeting from the user's speech.

Accordingly, present principles may be applied to desk-up and desk-down movement and need not be limited to two alternate desk heights (e.g., the desk may change between three or more discrete desk heights). Furthermore, in some examples, prior to desk movement, a notification for the user to cancel an upcoming desk height change may be displayed.

Other smart or IoT devices may be configured in sync with the desk (e.g., to sync with the current desk height). For example, if the user changes their audio setup between stand-alone speakers and headphones, which of those two devices presents audio could be changed when the desk position changes.

Accordingly, the device may determine when a desk height change is most opportune and then modify the desk's height at the opportune time based on user context/activity/presence.

What's more, in some examples the device that changes desk height may also configure still other IoT devices to whatever desk height to which the desk is being switched.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, solid state drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical Uls described herein may be consolidated and/or expanded, and UI elements may be mixed and matched between Uls.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

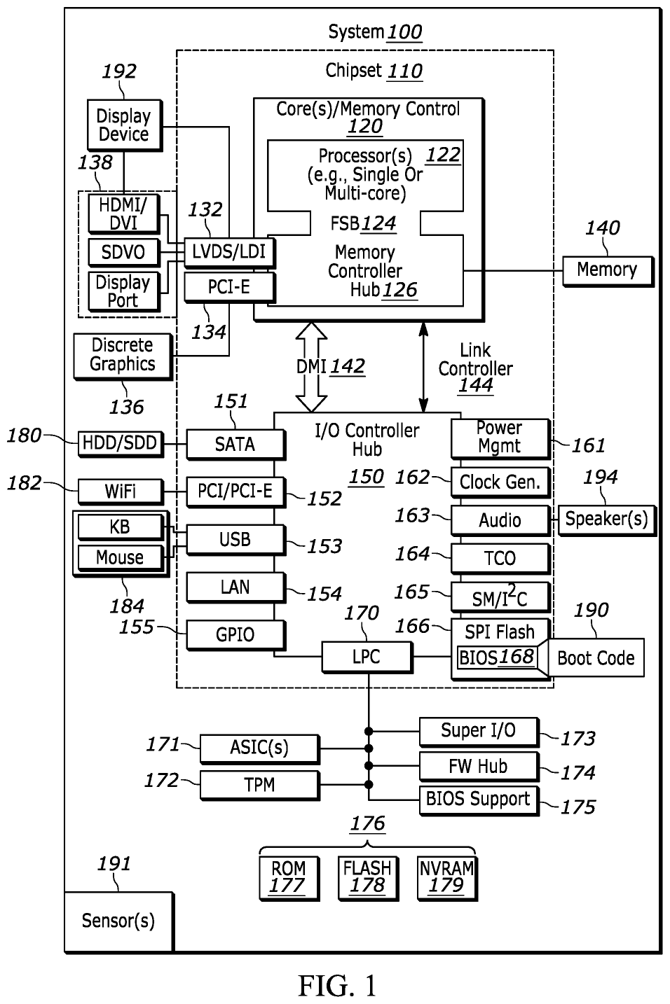

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include one or more sensors 191. The sensors 191 may include a laser rangefinder, for example. The sensors 191 may also include one or more motion sensors such as a gyroscope that senses and/or measures the orientation of the system 100 and provides related input to the processor 122, an accelerometer that senses acceleration and/or movement of the system 100 and provides related input to the processor 122, and/or a magnetometer that senses and/or measures directional movement of the system 100 and provides related input to the processor 122.

Additionally or alternatively, the sensors 191 may include an audio receiver/microphone that provides input from the microphone to the processor 122 based on audio that is detected, such as via a user providing audible input to the microphone. The sensors 191 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Still further, the sensors 191 may include a global positioning system (GPS) transceiver that is configured to communicate with satellites to receive/identify geographic position information and provide the geographic position information to the processor 122. However, it is to be understood that another suitable position receiver other than a GPS receiver may be used in accordance with present principles to determine the location of the system 100.

Other types of sensors consistent with present principles may also be included as one of the sensors 191.

It is to be understood that an example client device or other machine/computer may include fewer or more features than shown on the system 100 of FIG. 1. In any case, it is to be understood at least based on the foregoing that the system 100 is configured to undertake present principles.

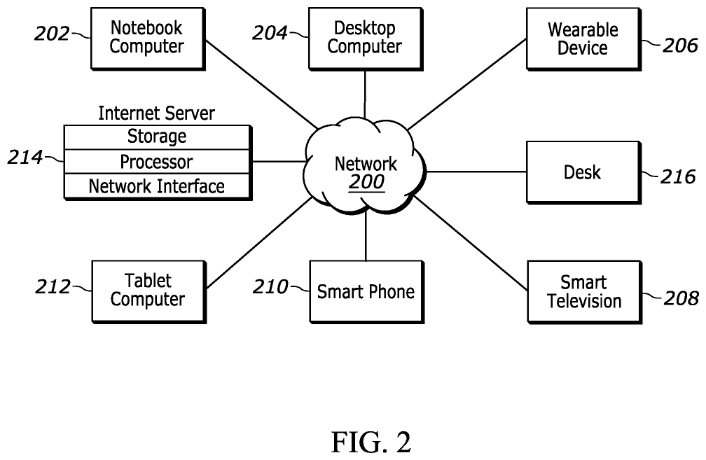

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, an electronic desk 216, and a server 214 such as an Internet server that may provide cloud storage accessible to the devices 202-212, 216. It is to be understood that the devices 202-216 may be configured to communicate with each other over the network 200 to undertake present principles.

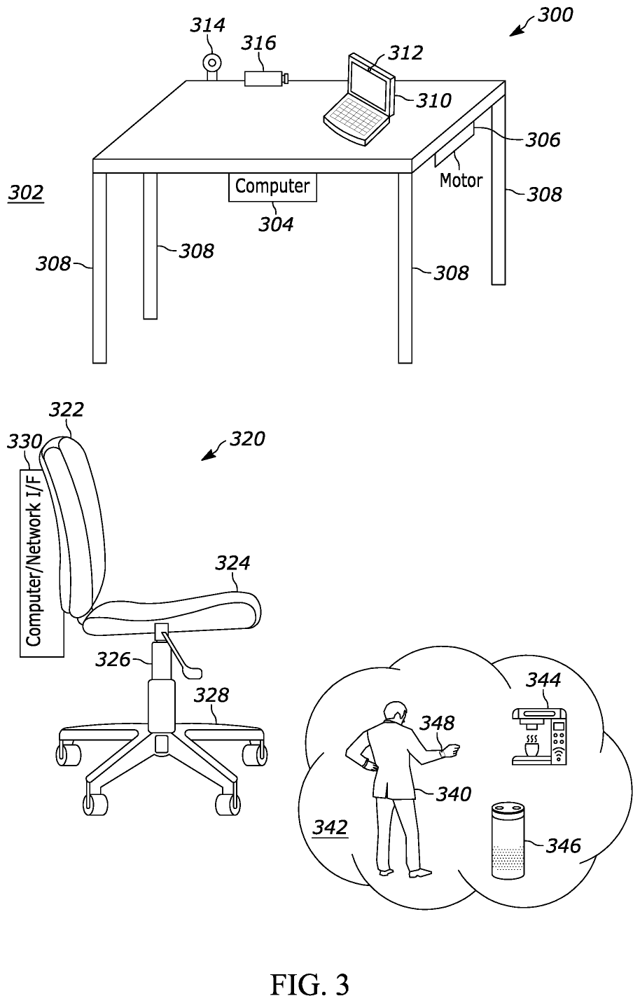

Now in reference to FIG. 3, an example explanatory diagram is shown. FIG. 3 therefore indicates that an electronic smart desk 300 may be disposed at a first location 302 of a building (e.g., particular room of the building). Being a smart desk, the desk 300 may include a computer 304 that may have similar components as the system 100 and, as such, may include a network interface for communicating with other devices consistent with present principles. The computer 304 may also be connected to and control an electric motor 306 that is actuatable to raise and lower the height of the desk 300 via respective telescoping desk legs 308 linked to the motor 306 and that may be controlled in unison to alter the height of the desk 300. However, note that other mechanisms besides telescoping desk legs may also be used to raise and lower a desk consistent with present principles and that this is but one example. For instance, the desk top may be composed of two surfaces in parallel horizontal planes, and arms and other linkage between the two may be actuatable under control of the motor 306 to raise and lower the upper surface with respect to the lower surface to change the overall height of the desk 300.

FIG. 3 also shows that a laptop computer 310 may be placed on the desk and may be in communication with the computer 304 via Wi-Fi, Bluetooth, or another type of wireless or even wired communication. The laptop 310 may include a camera 312 to provide images not just to one or more processors of the laptop 310 itself but also to the computer 304 consistent with present principles (e.g., so that the computer 304 may use the images to determine whether a user is within a proximity to the desk 300). Also for human presence detection and other purposes consistent with present principles, a stand-alone camera 314 may also be placed on or incorporated into the desk 300 for control by the computer 304 to receive images therefrom. A laser rangefinder 316 may also be disposed on the desk 300 for similar purposes (e.g., for human presence detection using infrared (IR) lasers and a time-of-flight algorithm).

FIG. 3 also shows an electronic smart chair 320 that may have a seat back 322 and seat bottom 324 along with a chair stand 326 having one or more legs 328. The chair 320 may also house a computer 330 with its own network interface for communicating with the laptop 310 and/or computer 304. For example, responsive to mechanical or electrical adjustment of the height of the chair 320 (e.g., adjustment of the chair's overall height by adjusting the height of the seat back 322 and/or seat bottom 324 up or down with respect to the legs 328 and ground), the computer 330 may communicate the adjustment amount and/or new overall height to the computer 304 and/or laptop 310 consistent with present principles (e.g., for either of the devices 304, 310 to adjust the height of the desk to maintain the same relative desk height to chair height for keyboard access, consistent monitor viewing height, etc.). Also note for completeness that as with the computer 304, the computer 330 may have similar components as the system 100 described above.

FIG. 3 further illustrates that a user 340 might be located at a second, different location 342 than the location 302, but still possibly within the same building (such as within a different room). The user 340 might interact with a smart home appliance at the location 342, such as turning on a smart coffee pot 344. The user 340 might also interact with a stand-alone digital assistant device 346 such as an Amazon's Alexa, Google's Assistant, Apple's Siri and/or HomePod, or a Lenovo hub device (e.g., to provide a trigger word and audible input of a command for the assistant device to execute, such as providing weather information or controlling another Internet of things (IoT) device such as smart blinds or even the coffee pot 344).

As also shown, the user might be wearing a wearable, network-enabled smart device such as a smart watch 348 that, among other things, may have its own camera, GPS transceiver, and motion sensors that may be used consistent with present principles. For example, those sensors may be used to respectively determine presence of the user 340 when proximate to the device 348, determine the location of the device 348 from which the location of the user 340 may be inferred, and determine movements of the user from which to infer physical exercise or even the lack thereof).

Accordingly, consistent with present principles, the devices 344, 346, and 348 may communicate with the computer 304 (or other device controlling the desk 300, such as the laptop 310) responsive to receipt of commands at those devices from the user 340 and/or responsive to other local interaction with the devices 344, 346, and 348. This in turn may be used by the computer controlling the desk 300 as a trigger to change the height of the desk 300 itself since the user not being present at the location 302 is an opportune time to do so.

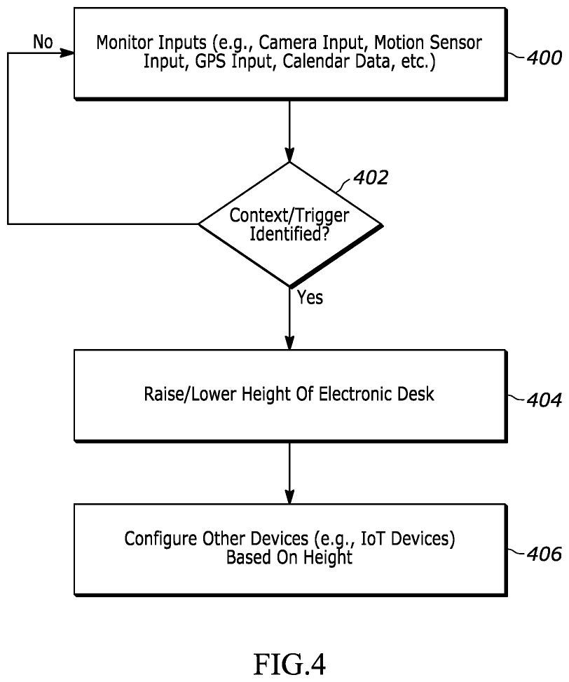

Continuing the detailed description in reference to FIG. 4, it shows example logic consistent with present principles that may be executed by a device such as the system 100, computer 304, laptop 310, and/or a remotely-located server in any appropriate combination. Note that while the logic of FIG. 4 is shown in flow chart format, other suitable logic may also be used.

Beginning at block 400, the device may monitor various inputs and/or data, such as camera input, motion sensor input, input from a GPS transceiver or other position receiver, calendar data related to events in an electronic calendar to which the device has access, and other inputs and data that may be used for triggering a height change of an electronic desk consistent with present principles. From block 400 the logic may then proceed to decision diamond 402.

At diamond 402 the device may determine, based on the inputs and data received/monitored at block 400, whether a context or other trigger has been identified for which to alter the height of the electronic desk. For example, at diamond 402 the device may determine whether a context associated with a particular user has been identified. A negative determination may cause the logic to proceed back to block 400, while an affirmative determination may cause the logic to proceed to block 404 where the device may autonomously control the electronic desk to alter its height (e.g., alternate between a lower height and a higher height at regular time intervals).

For example, the device may receive input from a camera such as one of the cameras described above in reference to FIG. 3. The device may then execute objection recognition, facial recognition, computer vision, and/or other image processing techniques to then determine whether a user is shown in the camera input (indicating the user is proximate) or specifically whether the user is within a predefined 3D area proximate to the electronic desk (such as a 3′×5′×3′ box-shaped area extending up from the ground and away from the front of the desk). Then, with the trigger being the user not being proximate to the electronic desk and with the device actually determining that the user is not proximate to the electronic desk, the device may proceed to block 404 where the device may raise or lower the height of the electronic desk (e.g., raise or lower the height of the desk if the current time of day is within a threshold amount of time before or after the end of an interval at which the desk height is to be changed).

Also note that a rangefinder like the rangefinder 316 may also be used to determine that the user is not proximate to the electronic desk (e.g., within the predefined 3D area) using a time-of-flight algorithm or other human presence detection to in turn alter the height of the electronic desk. Additionally or alternatively, input from a GPS transceiver on a wearable device or smartphone associated with a user may be received so the device of FIG. 4 may compare the coordinates indicated in the input to the current coordinates of the desk itself to determine whether the user is not proximate to the electronic desk.

As another example, the context may be identified based on input from at least one motion sensor, such as an accelerometer and/or a gyroscope on smartphone on the user's person or a wearable device being worn by the user (e.g., the device 348), with the input being transmitted to the device executing the logic of FIG. 4 over Wi-Fi, Bluetooth, etc. A dead reckoning algorithm may then be executed to infer device movement away from a known starting point and assume the device movement corresponds to movement of the user themselves to then determine whether the user is not proximate to the electronic desk based on the location of the device itself. If that device is not proximate, the height of the desk may be raised or lowered.

Additionally or alternatively, an activity detection algorithm and/or pattern recognition algorithm may be executed using the motion sensor input to determine whether the user is engaging in physical exercise such as jogging at more than a threshold speed or swinging a tennis racket in a predefined motion. In this specific example, if the user is determined to be engaging in physical exercise, then at block 404 the device may lower the height of the electronic desk so the user may sit at the desk, thus providing the user with some physical relief upon returning to the desk from physical exercise to minimizing any potential future leg or foot pain. Or if the user is determined to not be engaging in physical exercise, then at block 404 the device may raise the height of the electronic desk to provide the user an alternate physical disposition (standing) to minimize the effects of sitting too long, facilitate increased user productivity, allow the user to burn more calories than when sitting, and have relatively less back pain from sitting too long. Also note here that in some particular cases, the device may alter the height of the desk if the physical exercise (or lack thereof) is determined to occur within a threshold amount of time of a current time of day, and then alter the height of the desk if so (and decline to alter the height of the desk if outside the threshold amount of time).

Providing yet another example, the context may be identified based on data in an electronic calendar associated with the user. For example, the data may be a calendar event, and natural language understanding may be executed using text included in the calendar event to determine whether the calendar event indicates the user being at a location different from the location of the desk at a current time of day that is included in the time frame encompassed by the calendar entry. If the user is determined based on the calendar data to be at a different location, the device may then alter the height of the desk. Or as another example using multiple contexts, the calendar event may be parsed to determine that the user is both at a different location and engaging in physical exercise to then determine based on these two things that the desk height should be lowered for when the user comes back to the desk.

Providing still other examples, again note that the device of FIG. 4 may be communicating with other devices such as a network-enabled chair like the chair 320, an electronic home appliance like the coffee pot 344 or a smart oven or smart window blinds, a digital assistant like the device 346, or another type of device. The context may then be identified based on communication with one or more of those other devices. Thus, in one example input from the chair may be received that indicates that the user has changed the height of the chair so that the height of the desk may be changed up or down in the same direction to maintain the same relative height of the chair with respect to the desk. As another example, input from motion sensors and/or GPS transceivers on different chairs the user is switching between for use at the desk may be received, or even input indicating one chair has been powered off and another one powered on, so that the device may adjust the height of the desk to maintain the same relative positioning of chair height to desk height for the chair that is currently most-proximate to the desk (or chair that was turned on). As yet another example, input indicating current user interaction with a home appliance, smart window blinds, digital assistant device, or other type of device that is associated with the user and that is that is currently located at a different location than the desk may be used to determine that the user is not proximate to the desk itself and hence that the height of the desk may be changed.

Still in reference to FIG. 4, further note that in some implementations the logic may proceed from block 404 to block 406. At block 406 the device may configure other devices based on the altered height of the desk, such as configuring IoT devices on the desk itself. For example, the device may execute a self-learning or pattern recognition algorithm to determine that when the height of the desk has been lowered to a lower of two heights that the user has configured the desk to alternate between, the user uses headphones to listen to audio, while when the height of the desk has been raised to the higher position the user uses separate stand-alone speakers to listen to audio. Based on recognizing such patterns, at block 406 the device may switch which of the two audio output devices presents audio (e.g., from an active laptop) to the corresponding audio output device that matches the user's learned preferences for whatever height the desk has been placed in. Another example device combination for which switching to operative/active may occur may be a stand-alone microphone and separate built-in microphone on a laptop.

A certain configuration of a single device may even be changed at block 406 so that, for example, after learning that the user likes their smart window blinds open while the desk is at the higher of two heights and likes the blinds closed while the desk it at the lower of the two heights, the device may configure the blinds accordingly in the future to match the user's learned preferences for whatever height the desk has been placed in. As another example, after learning that the user likes a first brightness output level of five for the display of their laptop while the desk is at the higher height and likes a brightness output level of two while the desk it at the lower of the two heights, the device may configure the brightness output level accordingly in the future to match the user's learned preferences for whatever height the desk has been placed in. As yet another example, the device may control an electronic chair to electronically raise or lower the height of the chair itself so that the same relative height may be maintained between the chair and desk top before and after the desk height alteration.

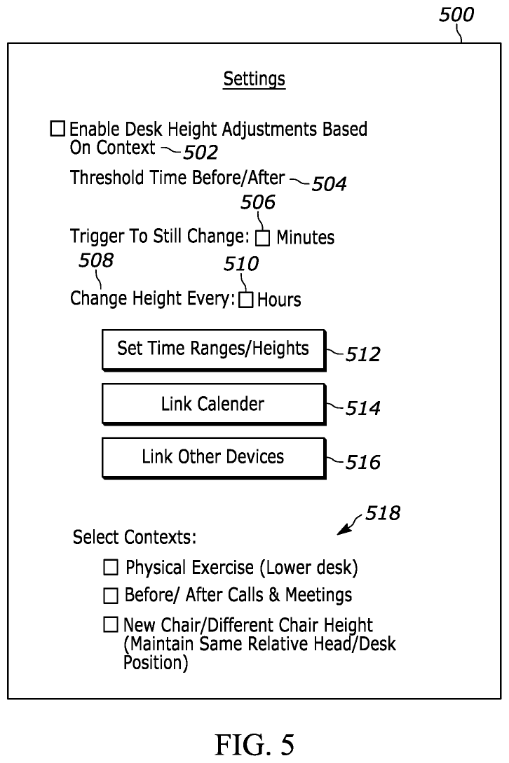

Now in reference to FIG. 5, an example graphical user interface (GUI) 500 is shown that may be presented on a display to which a device undertaking present principles has access. The settings GUI 500 may be reached by navigating a settings menu of the device itself or a dedicated electronic desk application menu, for instance. Also note that in the example shown, each option discussed below may be selected by directing touch or cursor or other input to the respective check box adjacent to the respective option.

As shown in FIG. 5, the GUI 500 may include an option 502 that may be selectable a single time to set or enable the device/system to undertake present principles in multiple future instances. For example, the option 502 may be selected to set or configure the device to execute the logic of FIG. 4 for multiple different desk height alterations at different times, and/or to execute other functions described herein in relation to altering the height of an electronic desk.

The GUI 500 may also include a setting 504 at which a threshold amount of time before or after a trigger is identified as occurring may be set. The user may set the threshold amount of time by providing numerical input to input box 506 to establish the threshold as a certain number of minutes or other time increment. Thus, the device may move forward or delay an alteration of desk height by no more than the threshold amount of time from when the corresponding trigger is identified/begins. Providing an example, if the desk is configured to alternate between two or three different heights in sequence at a regular time interval, but the user is determined to still be proximate to the desk at the end of a given time interval, the device may wait up until the threshold amount of time to perform the height alteration when the user is next determined to not be proximate to the desk. Or if desk height is to change both before an upcoming phone call indicated on the user's electronic calendar and while the user is not proximate to the desk, but the user is currently proximate to the desk, the device may wait up until the threshold amount of time to perform the height alteration when the user is next determined to not be proximate to the desk (to thus still make the height alteration before the call but while the user is not present).

Still in reference to FIG. 5, the GUI 500 may include a setting 508 at which a time interval for changing the height of the desk as described above may be specified by the end-user. Thus, for example, the user may direct numerical input to input box 510 to establish the interval as a particular number of hours or other time increment. Or, although not shown, different intervals may be established for different respective desk heights so that various intervals may be different lengths of time for respective desk heights that are configured in sequence.

Still further, the GUI 500 may include a setting 512 that may be selectable to command the device to present another GUI at which one or more specific times or time ranges may be set for alternating desk height between various heights (e.g., at regular or specified intervals during weekday business hours but not weekend hours and weekday hours after 8 a.m. to 5 p.m.). A selector 514 may also be presented as part of the GUI 500 and may be selectable to present another GUI at which identifying information may be provided by the user to link the user's electronic calendar to the device for access to the calendar as described above. Still further, the GUI 500 may include a selector 516 that may be selectable to present another GUI at which another device may be identified or paired with the device that changes desk height for communication between those two devices as described above.

Still further, if desired the GUI 500 may include various options 518 that may be respectively selectable to select different respective contexts or other triggers that may be used for changing desk height as described herein. Though any of the contexts/triggers described herein may be listed, for simplicity and as an example three options are shown in FIG. 5: A first option to use physical exercise as a trigger to lower the height of the desk, a second option to use a time before or after a call or meeting (e.g., as indicated in the user's electronic calendar) as a trigger to alter the height of the desk, and a third option to use a switching of chairs and/or chair height as another trigger to alter the height of the desk so that the same relative desk/head height may be maintained.

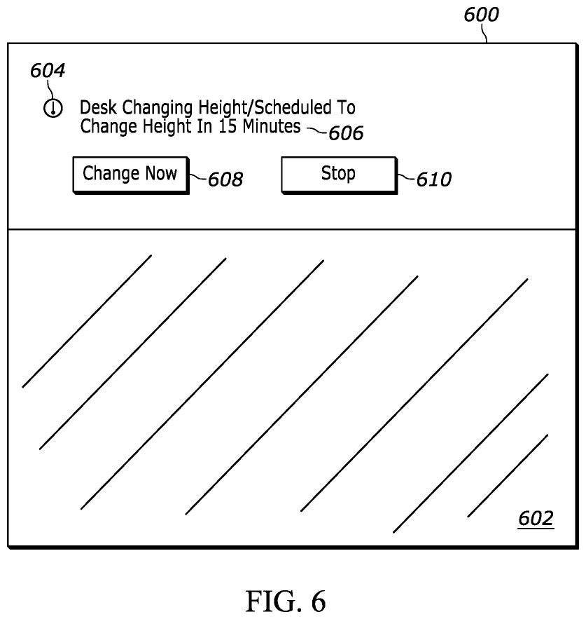

Now in reference to FIG. 6, another example GUI 600 is shown. The GUI 600 may be presented on the display of an electronic desk itself or the display of a connected device like the laptop 310 or smart watch 348. The GUI 600 may be presented responsive to determining that a condition is met for changing the desk's height, and/or responsive to determining that a condition will be met within a threshold time of a current time of day (e.g., fifteen minutes in the future when a desk height interval ends).

As shown, the GUI 600 may be presented as an overlay over other content 602 already being presented on the display, such as a word processing document or Internet video. As also shown, the GUI 600 may include a caution icon 604 and text 606 indicating that the height of the desk is changing or is scheduled to change at a specific time in the future. The GUI 600 may also include a selector 608 that is selectable to command the device to change the desk height at the current time (e.g., when it is otherwise scheduled to change in the future), and a selector 610 that is selectable to command the desk to not change the current desk height at any time responsive to whatever context triggered the GUI 600 to be presented.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor; and
storage accessible to the at least one processor and comprising instructions executable by the at least one processor to:
identify a context associated with a user; and
based on the context, alter a height of an electronic desk.

2. The device of claim 1, wherein the context is identified based on input from a camera.

3. The device of claim 2, wherein the instructions are executable to:
based on the input from the camera, determine that the user is not proximate to the electronic desk; and
based on the determination, alter the height of the electronic desk.

4. The device of claim 1, wherein the context is identified based on input from at least one motion sensor, the at least one motion sensor comprising one or more of: an accelerometer, a gyroscope.

5. The device of claim 1, wherein the context is identified based on input from a global positioning system (GPS) transceiver.

6. The device of claim 1, wherein the context is identified based on data in an electronic calendar associated with the user.

7. The device of claim 1, wherein the context is identified based on a current time of day.

8. The device of claim 1, wherein the context is identified based on the absence of the user within a proximity to the desk.

9. The device of claim 1, wherein the device is a first device, and wherein the context is identified based on communication a second device different from the first device.

10. The first device of claim 9, wherein the second device is a network-enabled chair.

11. The first device of claim 9, wherein the second device is an electronic home appliance.

12. The first device of claim 9, wherein the second device is located in a first location different from a second location at which the electronic desk is located, and wherein the context is identified based on user interaction with the second device.

13. The first device of claim 1, wherein the context is related to the user engaging in physical exercise, and wherein the instructions are executable to:
lower the height of the electronic desk.

14. The first device of claim 1, wherein the context is related to the user not engaging in physical exercise, and wherein the instructions are executable to:
raise the height of the electronic desk.

15. The device of claim 1, comprising the electronic desk.

16. A method, comprising:
identifying a context associated with a user; and
based on the context, altering a height of an electronic desk.

17. The method of claim 16, comprising:
altering the height of the electronic desk a threshold time before the context is identified to occur.

18. The method of claim 16, wherein the context is identified using human presence detection and input from a time-of-flight sensor.

19. At least one computer readable storage medium (CRSM) that is not a transitory signal, the at least one CRSM comprising instructions executable by at least one processor to:
identify a trigger for autonomously altering a height of an electronic desk; and
based on the trigger, alter the height of the electronic desk.

20. The at least one CRSM of claim 19, wherein the trigger comprises one or more of:
a user switching chairs used to sit at the electronic desk, the user changing a height of a chair used to sit at the electronic desk.
